(19) United States
(12) Patent Application Publication
(10) Pub. No.: US 2016/0092771 A1
(43) Pub. Date: Mar. 31, 2016

(54) ANALYSIS OF SOCIAL MEDIA MESSAGES

(71) Applicant: International Business Machines Corporation, Armonk, NY (US)

(72) Inventors: Stephen J. Buckley, White Plains, NY (US); Markus R. Ettl, Yorktown Heights, NY (US); Matthias O. Frey, Zurich (CH); Prateek Jain, White Plains, NY (US); Ronny Luss, New York, NY (US); Marek Petrik, Croton on Hudson, NY (US); Rajesh Kumar Ravi, Yorktown Heights, NY (US); Chitra Venkatramani, Roslyn Heights, NY (US)

(21) Appl. No.: 14/496,060

(22) Filed: Sep. 25, 2014

(51) Int. Cl. G06N 5/04; H04L 29/08; H04L 29/06; G06N 7/00

(52) U.S. Cl. CPC G06N 5/04; G06N 7/005; H04L 67/02; H04L 67/42

(57) ABSTRACT

In a method for analyzing social media messages, the method includes one or more processors analyzing social media messages utilizing a set of topics and keywords associated with a brand. The method further includes one or more processors identifying social media messages that include information relating to the brand utilizing the analysis of social media messages utilizing the set of topics and keywords. The method further includes one or more processors determining relevancy scores for the identified social media messages that provide an indication of the percentage likelihood that a social media message is related to the brand. The method further includes one or more processors determining one or more recommendations of social media users associated with social media messages based on the determined relevancy scores.

### BACKGROUND OF THE INVENTION

The present invention relates generally to the field of social media, and more particularly to social media messaging.

A social media network is a mechanism that facilitates connection between people and information in an organized manner, which enables and facilitates the sharing of information between members of the social media network. Social media network services consist of a representation of each user (e.g., a profile), social links, and a variety of additional services. A large number of web-based social media networks exist (i.e., online social networks), which include services that allow users of the social media network to create a public profile, to create a list of users with whom to share a connection, and to share and send messages throughout the network.

A common mechanism for sharing information on a social media network is through the use of messages, which can be directed from one user to another user, or posted to an activity stream that is capable of being viewed by a plurality of users. Social media networks and other social media services utilize keywords in social media messages and demographics of social media users to target promotional social media messages.

### SUMMARY

Aspects of the present invention disclose a method, computer program product, and system for analyzing social media messages. The method includes one or more processors analyzing social media messages utilizing a set of topics and keywords associated with a brand. The method further includes one or more processors identifying social media messages that include information relating to the brand utilizing the analysis of social media messages utilizing the set of topics and keywords. The method further includes one or more processors determining relevancy scores for the identified social media messages that provide an indication of the percentage likelihood that a social media message is related to the brand. The method further includes one or more processors determining one or more recommendations of social media users associated with social media messages based on the determined relevancy scores. In another aspect of the invention, the method further includes one or more processors receiving a selection of one or more of the recommendations of social media users and sending a promotional campaign brand message to the received selection of one or more social media users.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for determining recommendations of users to send a promotional message to, based on determined relevancy scores of a social media message associated with the users, in accordance with embodiments of the present invention.

FIG. 3 depicts an example web dashboard, in accordance with embodiments of the present invention.

FIG. 4 depicts a block diagram of components of a computing system representative of the client device and server of FIG. 1, in accordance with an embodiment of the present invention.

### DETAILED DESCRIPTION

Embodiments of the present invention allow for identifying social media users that may be interested in a product or service. In one embodiment, social media messages are analyzed in comparison to keywords and topics associated with a product. The users, or user profiles corresponding to messages that, based on the analysis, relate to the product are sent a promotional message that notifies the users of information relating to the product. Additional embodiments of the present invention can determine probabilistic relevance models based on product descriptions and then tune the models based on observed performance.

Some embodiments of the present invention recognize that keyword and demographic matching can be imprecise when utilizing social media messages. The large volume of social media messages that are available can lead to a difficulty in deploying efficient social media campaigns. A product-customized targeting strategy can lead to a marketing campaign with increased precision.

Social media plays an increasingly important role in how customers both express their interests and discover relevant products. It is, as a result, important that businesses can respond to trends and interests expressed in social media and engage both existing and potential customers. The content in social media (e.g., social media messages) can be used to better target potential customers. Additional embodiments of the present invention recognize that a single product catalog can contain numerous types of products and that the type of language used in product catalogs can be quite different from the language used in social media.

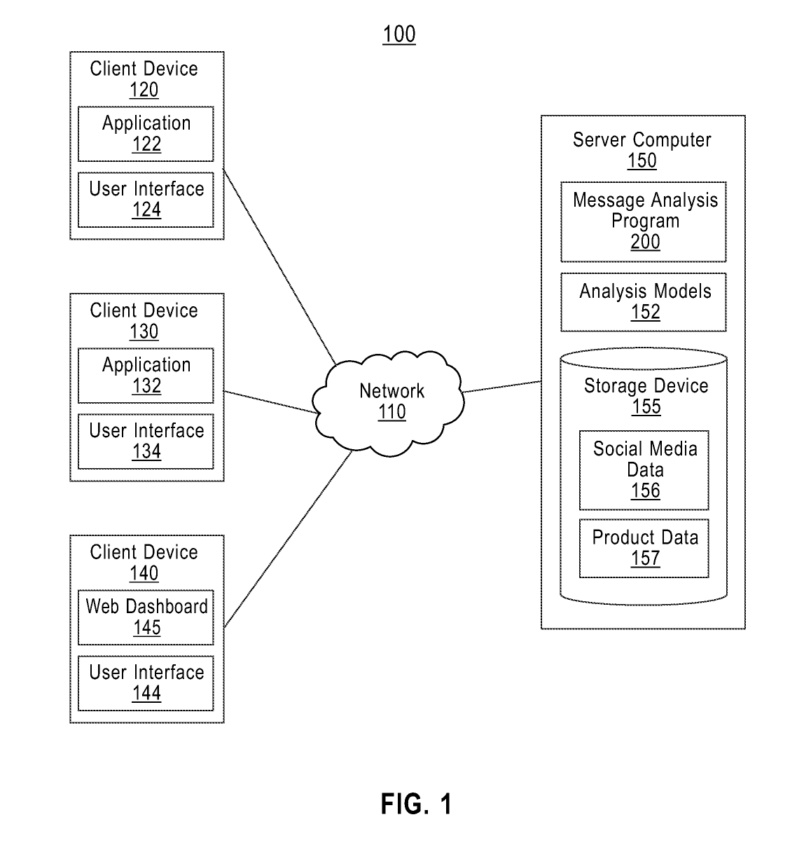

The present invention will now be described in detail with reference to the Figures. FIG. 1 is a functional block diagram illustrating a distributed data processing environment, generally designated 100, in accordance with one embodiment of the present invention.

An embodiment of data processing environment 100 includes client devices 120, 130, and 140, and server computer 150, all interconnected over network 110. In one embodiment, client devices 120, 130, and 140, and server computer 150 communicate through network 110. Network 110 can be, for example, a local area network (LAN), a telecommunications network, a wide area network (WAN) such as the Internet, or any combination of the three, and include wired, wireless, or fiber optic connections. In general, network 110 can be any combination of connections and protocols that will support communications between client devices 120, 130, and 140, and server computer 150, in accordance with embodiments of the present invention.

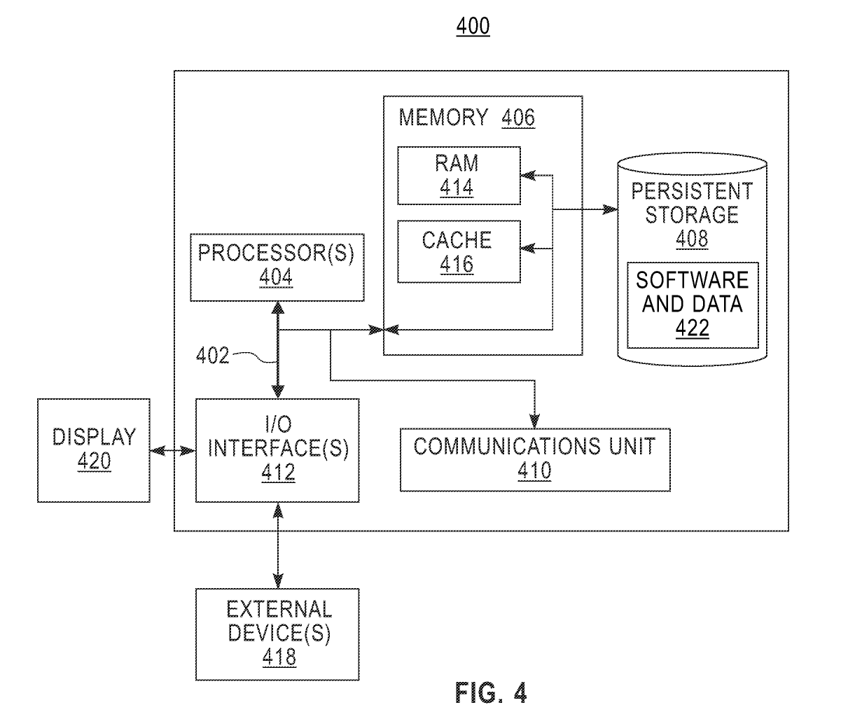

In various embodiments of the present invention, client devices 120, 130, and 140 may be workstations, personal computers, personal digital assistants, mobile phones, or any other devices capable of executing computer readable program instructions, in accordance with embodiments of the present invention. In general, client devices 120, 130, and 140 are representative of any electronic device or combination of electronic devices capable of executing computer readable program instructions. Client devices 120, 130, and 140 may include components as depicted and described in further detail with respect to FIG. 4, in accordance with embodiments of the present invention.

In one embodiment, client devices 120 and 130 are associated with users of a social media service, and client device 140 is associated with server computer 150, which analyzes the social media service and messages posted to the social media service. Client devices 120 and 130 include respective instances of applications 122 and 132. In one embodiment, applications 122 and 132 are web browsers that users of client device 120 and 130 utilize to access a social media service and post messages (e.g., via user interfaces 124 and 134) on the social media service. In various embodiments, applications 122 and 132 include user profile information associated with users of client device 120 and 130 that utilize social media networks.

Client devices 120, 130, and 140 include respective instances of user interfaces 124, 134, or 144. User interfaces 124, 134, and 144 are programs that provide an interface between a user of client devices 120, 130 and 140 and a plurality of applications that reside on the client devices. A user interface, such as user interfaces 124, 134, or 144, refers to the information (such as graphic, text, and sound) that a program presents to a user and the control sequences the user employs to control the program. A variety of types of user interfaces exist. In one embodiment, user interface 124, 134, and 144 are graphical user interfaces. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements.

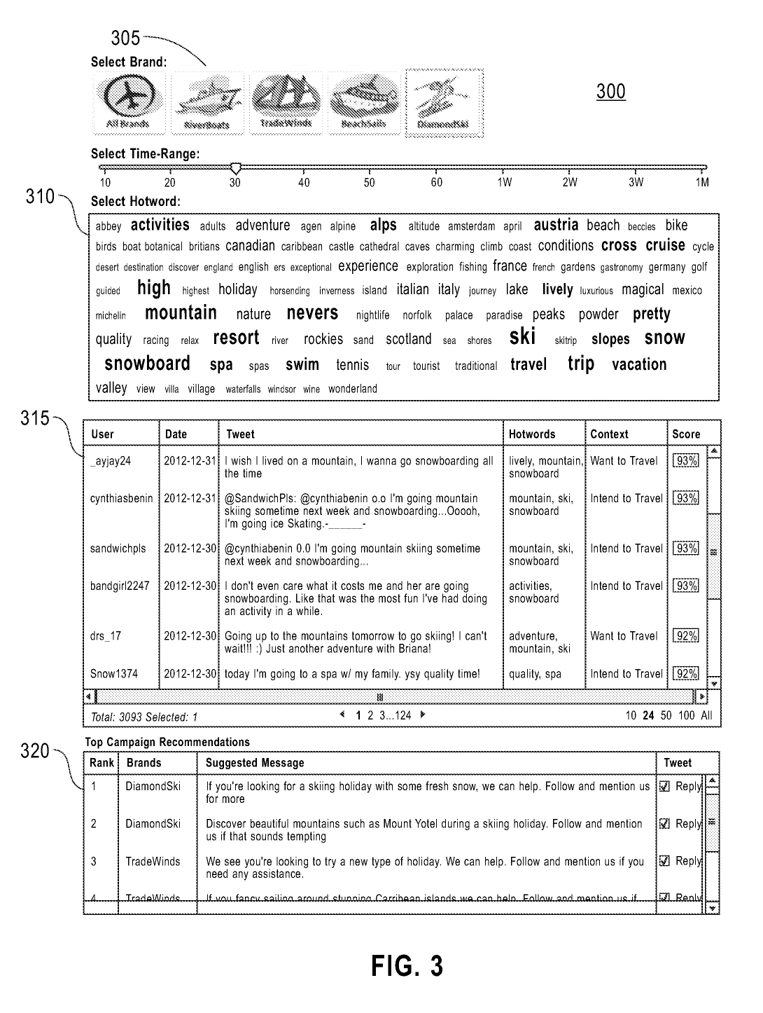

Client device 140 also includes web dashboard 145. Web dashboard is a web-based GUI that a user of client device 140 can utilize to browse the scored social media messages and to engage relevant users. Web dashboard 145 is also capable of providing insights into the popularity of travel destinations and keywords, as well as overall social media activity. FIG. 3 depicts example web dashboard 300, which includes travel brands 305, keyword listing 310, message recommendations 315, and promotional messages 320. Travel brands 305 is a selection of travel brands that a user of example web dashboard 300 can select and utilize to analyze social media messages. Keyword listing 310 displays keywords associated with a selected brand, which vary in size depending on the frequency of the keyword in scored social media messages. Message recommendations 315 lists the various social media messages sorted by their relevancy scores along with various relevant user profile data. Promotional messages 320 lists promotional campaign messages that are associated with brands that can be sent out to the social media users.

In example embodiments, server computer 150 can be a desktop computer, a computer server, or any other computer systems known in the art. In certain embodiments, server computer 150 represents computer systems utilizing clustered computers and components (e.g., database server computers, application server computers, etc.) that act as a single pool of seamless resources when accessed by elements of data processing environment 100 (e.g., client devices 120, 130, and 140). In general, server computer 150 is representative of any electronic device or combination of electronic devices capable of executing computer readable program instructions. Server computer 150 may include components as depicted and described in further detail with respect to FIG. 4, in accordance with embodiments of the present invention.

In various embodiments, server computer 150 represents a combination of server computers that communicate and process information corresponding to messages posted to social media networks. In an example embodiment, server computer 150 includes server computers capable of managing and analyzing structured and unstructured data (e.g., social media messages) and perform text analytics to provide structure to unstructured data (e.g., to deduplicate messages and/or filter out unrelated messages). In another example embodiment, server computer 150 can also include an extract, transform, and load (ETL) server, which can provide data integration between various systems (e.g., client devices 120 and 130, social media messages from a plurality of sources, etc.). In an additional example embodiment, server computer 150 can also include server computers to host and provide a dashboard for accessing and utilizing data on server computer 150 (e.g., web dashboard 145).

Server computer 150 includes analysis models 152, storage device 155, and message analysis program 200. In one embodiment, analysis models 152 includes probabilistic models that server computer 150 and message analysis program 200 can utilize to analyze social media data 156 and product data 157. Analysis models 152 also includes models and algorithms that utilize Natural Language Processing (NLP) and other forms of text analytics. In additional embodiments, server computer 150 can modify analysis models 152 in response to user feedback (e.g., a user of server computer 150 or client device 140). Message analysis program 200 determines recommendations of users to send a promotional message to, based on determined relevancy scores of a social media message associated with the users, in accordance with embodiments of the present invention.

Storage device 155 includes social media data 156 and product data 157. Storage device 155 can be implemented with any type of storage device, for example, persistent storage 408, which is capable of storing data that may be accessed and utilized by server computer 150, such as a database server, a hard disk drive, or a flash memory. In other embodiments, storage device 155 can represent multiple storage devices within server computer 150.

Social media data 156 includes social media messages and data that is associated with the social media messages. In various examples, the social media messages can be from a single social media network or from a plurality of social media networks. In additional examples, the social media messages can be any form of messaging utilized in a social media network (e.g., messages directed to or from one user to one or more additional users, messages posted to an activity stream on a social media network, etc.). In one embodiment, server computer 150 stores social medial messages in social media data 156 utilizing stream data processing. For example, server computer 150 captures live social media messages in real-time and periodically stores the social media messages in social media data 156.

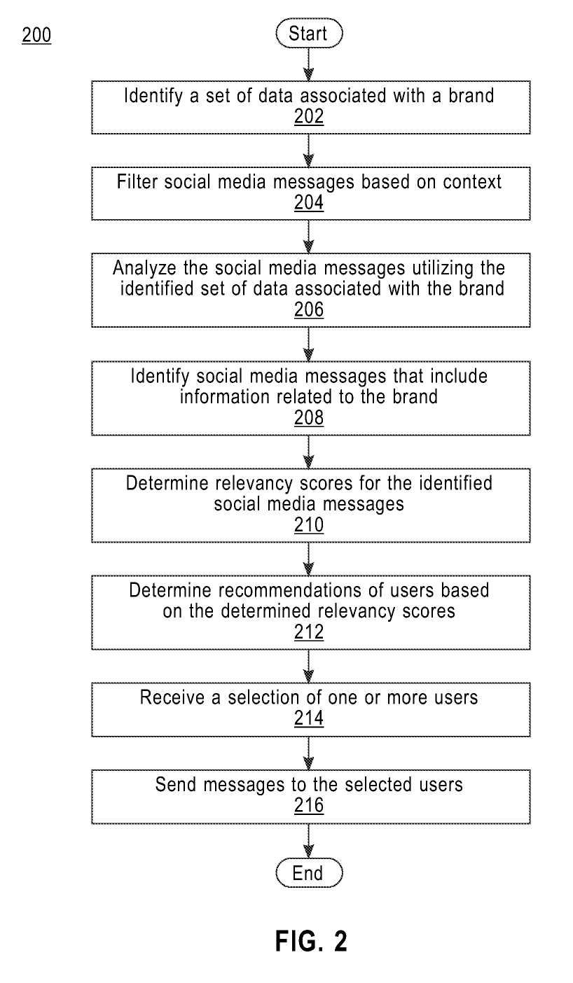

In addition, social media data 156 includes user profile information associated with social media messages. For example, if a user of client device 120 posts a social media message that server computer 150 stores in social media data 156, then social media data 156 associates the social media message to the user profile of the user of client device 120. The associated user profiles can includes additional social media messages posted by the user, an association to the social media account of the user that can receive messages (e.g., targeted promotional messages from server computer 150), an additional user profiles that are associated with the user profile (e.g., friends of the user, etc.). In another embodiment, social media data 156 includes metadata associated with social media messages. For example, the metadata can include data that a social media message was posted, user profiles references in a social media message, the location that the user posted the social media message, etc. In another example, social media data 156 includes metadata of context information associated with social media messages, which can be determined by message analysis program 200 and analysis models 152. The context information can indicate sentiment and/or intent associated with a social media message and is discussed in further detail with regard to FIG. 2.

Product data 157 includes brand and product information. In one embodiment, product data 157 includes one or more product catalogs, which include a plurality of products and descriptions that correspond to the products and the brands associated with the products (e.g., a text description of a product or service, corresponding prices, etc.). For example, product data 157 includes product catalogs of multiple travel company brands, and the product catalogs for each brand provide text descriptions of products that the brand offers. In another embodiment, product data 157 includes promotional messages (e.g., brand and product advertising campaign messages) that can be sent as a social media message to users. In various embodiments, product data 157 includes topics and keywords that are associated with brands and products. For example, a travel company (i.e., a brand) offers cruises (i.e., a product), and product data 157 includes a dictionary of associated topics and keywords that include “ski, skiing, mountain, and slopes.”

In an example embodiment, server computer 150 utilizes one or more models in analysis models 152 to process product information in a manner that can be related to text of social media messages. An example framework for processing text in both social media messages and product information is the “bag-of-words” framework in which a block of text is transformed into a vector of word counts based on a predetermined set of words called a dictionary. For example, the social media message, “I want to go skiing at a cheap resort next weekend” and a dictionary composed of the five words: “hotel, mountain, resort, skiing, snowboarding.” The corresponding vector of word counts is [0, 0, 1, 1, 0]. Similarly, vectors of word counts can be constructed based on text descriptions of products such as those found in product catalogs. Analyzing product information to identify topics and keywords for brands that might have many products of very close similarity can be of increased difficulty.

A product catalog for a brand or company advertises products in a product catalog, and rather than represent a product catalog as many individual entities, product data 157 includes data that summarizes the product catalog by a small number of topics that captures the overall product information contained in the catalog. For example, the topics are determined utilizing topic modeling in machine learning. The topics, instead of the products themselves, can be related and compared to the social media messages (e.g., of social media data 156) and the brands for which there is high similarity to one of the brand's topics are recommended.

In an example embodiment, server computer 150 utilizes a matrix factorization topic model, which is included in analysis models 152. The model denotes N as the number of features (i.e., the number of distinct relevant words in the product catalog), M as the number of products in the catalog, and K as the number of topics intended for output. Let X be a matrix of word counts representing a product catalog where Xᵢⱼ is the number of time word j appears in the description of product i. In this example embodiment, the assumption is that each product description can be summarized by K topics, where K is much smaller than the number of words in the dictionary. This means that rather than represent a product by N word counts (assuming a dictionary with N words), the product description can be represented by K topic coefficients. Next, the model utilizes an optimization problem that utilizes a matrix factorization representation of a product catalog, which is motivated by the assumption that the catalog information, input as a matrix with N numbers for each product, can be represented by the product of two matrices with far fewer parameters. The following optimization problem is utilized:

$$min {‖ X - {WH}^{T} ‖}_{F}^{2} subject to W , H \geq 0 , {\sum }_{i = 1}^{N} {H}_{ij} = 1 for all j = 1 , … , K \qquad ( 1 )$$

The optimization problem (1) searches for the best matrix W of topic coefficients and matrix H of topic scores that approximate the catalog matrix X. The i^{th} row of W is a vector of K coefficients that summarize product i. The k^{th} column of H is a vector of N scores (one for each of the N possible words) that represents the k^{th} topic. This representation means that the j^{th} word in the i^{th} product can be written as a linear mapping of the k topic scores in each of the k topics, i.e. Xᵢⱼ=<wᵢ,hᵢ> where W, is the i^{th} row of W and hⱼ is the j^{th} row of H. The non-negativity constraints on W, H are for interpretation—it is not clear what a negative topic coefficient would mean while positive combinations have a clear meaning. The last constraint enforces that each topic is a distribution over the N words and regularizes the optimization problem, which has two important implications. First, learning topics as distributions over words allows us to compute the probability that each topic generates a given piece of text, which is elaborated in the following section on recommending brands. Second, regularization prevents the occurrence of an infinite number of solutions—without the constraint, if (W,H) is a solution then (cW,H/c) would be a solution for all c>0.

Optimization problem (1) is only one variation of an analysis model (e.g., in analysis models 152) that server computer 150 can utilize. For example, given information about products, additional penalties can be added that force the coefficient vectors in W for similar products to be close to each other. In another example, server computer 150 can utilize a different family of models for learning topics such as Latent Dirichlet Allocation (LDA), which is a more structured model.

In the example embodiment of optimization problem (1), server computer 150 determines local minima of optimization problem (1). Server computer 150 utilizes alternating minimization (i.e., Gauss-Seidel), whereby server computer 150 starts with initial values for W and H, and on each iteration, server computer 150 first fixes W and minimizes over H, and then fixes H and minimizes over W. When H is fixed, the resulting problem can be decomposed into M (the number of products in the catalog) separate non-negative least squares problem where each problem optimizes over a row of W, which server computer 150 can solve with an accelerated projected gradient descent method. When W is fixed, server computer 150 can again use an accelerated projected gradient descent method over the variable H. While the gradient computation cannot be decomposed, the projection problems can be decomposed, so that projection requires solving K projection problems onto the simplex. The alternating minimization scheme terminates when the decrease in the objective function is below some threshold. This classic alternating minimization algorithm is commonly used in matrix factorization problems.

FIG. 2 is a flowchart depicting operational steps of message analysis program 200, a program for determining recommendations of users to send a promotional message to, based on determined relevancy scores of a social media message associated with the users, in accordance with embodiments of the present invention. In one embodiment, message analysis program 200 initiates in response to a request from an individual utilizing client device 140 (e.g., via web dashboard 145 and/or user interface 144).

In step 202, message analysis program 200 identifies a set of data associated with a brand. In one embodiment, a user of client device 140, through web dashboard 145, makes a selection of a brand (or product) and in response message analysis program 200 identifies a set of data that is associated with the selected brand. The set of data includes information associated with the selected brand that is stored in product data 157, including topics and keywords. In an example, a user of client device 140 makes a selection of the “Diamond Ski” brand in travel brands 305 in example web dashboard 300 (FIG. 3), and in response message analysis program 200 identifies the topics and keywords that are associated with the Diamond Ski brand and stored in product data 157.

In step 204, message analysis program 200 filters social media messages based on context. In one embodiment, message analysis program 200 filters social media messages stored in social media data 156 based on the context of the social media messages. Message analysis program 200 utilizes text extractors, which include rules for analyzing text. In an example embodiment, message analysis program 200 utilizes text extractors to analyze social media messages to determine the intent of messages, which provides an indication of whether the message describes a past experience or a desired experience. In another example embodiment, message analysis program 200 filters out social media messages that include promotional content or other non-authentic social media user messages. Message analysis program 200 filters the social media messages that are stored in social media data 156 to identify, and subsequently utilize, social media messages with an appropriate context.

In step 206, message analysis program 200 analyzes the social media messages utilizing the identified set of data associated with the brand. In one embodiment, message analysis program 200 utilizes text extractors that utilize topics and keywords associated with the brand to identify social media messages from a set of filtered social media messages from step 204, which include information relating to the brand.

Social media messages can be composed of unstructured text, which is unlike text in traditional articles such as news articles, as unstructured text does not conform to conventional grammar rules. Wide-spread use of abbreviations (e.g., “want 2 c” instead of “want to see”) can make the task of extraction and normalization complex. In order to address this problem, message analysis program 200 utilizes text extractors that provide rule-based text analytics languages (e.g., Annotation Query Language (AQL), Sequential Query Language (SQL), etc.). The basic building block of AQL is a view, which may be created via dictionary matches, regular expression searches, and combinations of other views. Message analysis program 200, utilizing AQL, can also provide functionality for efficient compilation and computation (using Map-Reduce) of the rules. Many queries that message analysis program 200 utilizes in the text extractors are fairly simple. For example, social media messages from users that like to travel can be identified simply by searching for a few phrases, such as “likes to travel” and “traveler” in a description field of a user profile. In other examples, the text extractors can be much more complex and require thousands of lines of AQL to build the desired rules.

In an example embodiment, message analysis program 200 utilizes text extractors that include rules for locating social media messages and users interested in a specific outdoor activity, such as kayaking. Social media user profile description attributes are intended to describe the author of a social media message, and thus, frequently includes phrases such as “professional kayaker,” “photographer,” and “filmmaker.” While the phrases are all perfectly understandable as self-descriptions to a human reading the user profile description field, if viewed outside of the context it would be difficult to tell whether the author was the kayaker or a third party. The rules thus can be tailored to the description field. Using words such as “kayaker” and “rafter” can provide a good basis for finding a kayaker from the description field, and the rules work fairly well with some filtering on top (e.g., in step 204). For example, while the social media message, “Cruise with me on this wild ride” could indicate that the author is on a cruise, the example references a time period filled with uncertainty. As another example, it is helpful to filter out references that appear after “car” (e.g., “car cruise control”).

Message analysis program 200 utilizes AQL and is capable of making complex patterns. For example, one common travel construction not caught by the above rules is found in text such as “My ideal camera for roaming the world? Read and find out what I think.” These are usually found in user profile description text, but message analysis program 200 can apply the profile text against the social media text as well. Sample AQL code defining a single pattern that is identifiable with a traveler that has intent on a particular activity is given by:

create view newActivity_Love_Phrase as extract
nap.activity_name as activity,
pattern/[Ww]ould/<Token>{0,1}<nalp.like_phrases><Token>{0,3}<nap.activity_name> as keyPhrase from
newActivity_phrases nap, newActivity_like_phrases nalp;

The above rule searches for “would,” followed by zero or one words (such as “totally”), followed by a phrase indicating desire (such as “like” or “love”), a few descriptive tokens (such as “adventurous” and “sunny”), and concluding with an activity word (e.g., “cruise,” “kayaking,” etc.). Message analysis program can allow three tokens between “have” and the activity word in order to address cases with multiple adjectives such as “Would totally love to go on a cruise!”

In step 208, message analysis program 200 identifies social media messages that include information related to the brand. In one embodiment, message analysis program 200 identifies social media messages that include information related to the brand (i.e., the brand from step 202) based on the analysis of social media messages in step 206. In example embodiments, message analysis program 200 identifies social media messages from social media data 156 (filtered in step 204) that include text of the topics and keywords associated with the brand (from step 202). In another example embodiment, message analysis program 200 identifies social media messages that include information related to the brand in response to a user selection (e.g., via a user of client device 140 utilizing web dashboard 145). For example, message analysis program 200 receives a selection of a keyword in keyword listing 310 of example web dashboard 300. In response, message analysis program 200 identifies social media messages that include text that relates to the selected keyword.

In step 210, message analysis program 200 determines relevancy scores for the identified social media messages. In one embodiment, message analysis program 200 determines relevancy scores for the social media messages identified in step 208. A relevancy score provides an indication of the likelihood that a social media message is related to a particular brand or product. In various embodiments, message analysis program 200 determines a relevancy score that indicates a correlation between social media messages and products of a brand.

Message analysis program 200 utilizes the text extractors (described above) as an initial filter to locate social media messages and corresponding users. Message analysis program 200 uses the text extractors first because the text extractors can be designed to look for particular patterns, locations, etc. and can detect the context (such as whether a user intends to buy something) of social media messages. In example embodiments, message analysis program 200 first passes all social media messages through the text extractors, which leaves a set of messages that exhibit intent and context.

Message analysis program 200 inputs the filtered social media messages and, one-by-one, ranks the brand-specific topics according to which topics are most similar to each social media message. Message analysis program 200 utilizes topics, which are distributions over the words. In the following model, denote h as a vector holding the distribution of a topic, with each component being the probability of a word given the topic, and let x be a vector holding the word count of a social media message. One of the main issues with understanding social media messages is that the language used by people on a social media network can be very different from the language used in product catalogs, namely the bag-of-words used to build x is very different from the bag-of-words used to describe topics. Let N be the number of distinct words in the message. Message analysis program 200 extends topic h such that the topic has a probability for every word in x; for each word that does not appear in the topic distribution, we assign a default minimum probability. Message analysis program 200 then computes the likelihood of observing x given topic h as:

Πᵢ₌₁^{N}(hᵢ)^{x}^{ᵢ}, (2)

for each topic. Note that, since the dictionary is based on the words in the social media message, the likelihoods of different topics are still comparable, as words not appearing in the catalog dictionary factor in each likelihood equivalently. Message analysis program 200 then calculates a relevancy score for each topic as a function of the likelihood and any other information that one might have about the social media message. In some social media networks, social media message can have additional associated information, but profiles can be built on active users. In various embodiments, certain recommendation tasks might give higher relevance to users according to things such as their gender, location, etc.

In step 212, message analysis program 200 determines recommendations of users based on the determined relevancy scores. In one embodiment, message analysis program 200 compares the determined relevancy scores for social media messages (determined in step 210) to a threshold condition. Message analysis program 200 determines which users are associated with the social media messages that exceed the threshold condition and provides the determined user as recommendations. In an example embodiment, message analysis program 200 compares the determined relevancy scores for social media messages to a threshold condition of a minimum 90% relevancy score. Message analysis program 200 determines the user associated with the social media messages with a minimum 90% relevancy score and provides the social media messages and the users as recommendations (e.g., to client device 140 via web dashboard 145). For example, message analysis program 200 displays message recommendations 315 in example web dashboard 300, which includes a depiction of the social media message, the corresponding user, the corresponding relevancy score, and other information associated with the social media messages.

In step 214, message analysis program 200 receives a selection of one or more users. In one embodiment, message analysis program 200 receives a selection of one or more of the determined recommendations of users (from step 212) via user input into web dashboard 145 of client device 140. In another embodiment, message analysis program 200 receives a selection of one or more social media messages with a relevancy score that meets or exceeds the threshold condition, and message analysis program 200 identifies the corresponding users. In an additional embodiment, message analysis program 200 can receive a selection of a promotional campaign message to send to the selected users. In an example embodiment, message analysis program 200 receives a selection of one or more users displayed in message recommendations 315 in example web dashboard 300. Additionally, message analysis program 200 receives a selection of a promotional campaign message in promotional messages 320 in example web dashboard 300.

In step 216, message analysis program 200 sends messages to the selected users. In one embodiment, message analysis program 200 sends a promotional campaign message to the selected users (from step 214). In various embodiments, message analysis program 200 can receive a selection of a promotional campaign message to send, or message analysis program 200 can send a default promotional campaign message that is associated with the brand (from 202).

In an example, a user of client device 140 utilizing example web dashboard 300 makes a selection of the “Diamond Ski” travel brand in travel brands 305 and in response, message analysis program 200 identifies topics and keywords that are associated with Diamond Ski (step 202). Message analysis program 200 displays topics and keywords associated with Diamond Ski in keyword listing 310. Message analysis program 200 filters social media messages that are stored in social media data 156 based on context (step 204). Then, message analysis program 200 analyzes the filtered social media messages utilizing the identified topics and keywords (step 206) and identifies social media messages that include information related to the topics and keywords corresponding to Diamond Ski (step 208). Message analysis program 200 determines relevancy scores for the identified social media messages (step 210) and determines recommendations of the social media messages that have a relevancy score that meets or exceeds a threshold condition (step 212). In response to receiving a selection of a topic or keyword in keyword listing 310, message analysis program 200 displays social media messages (and related data) that are related to the selected topic or keyword in message recommendations 315. Message analysis program 200 receives a selection of one or more of the social media users (or corresponding social media messages) in message recommendations 315 (step 214) and receives a selection of a promotional campaign message in promotional messages 320. In response to receiving the selection of one or more users and a promotional campaign message, message analysis program 200 sends the selected promotional campaign message to the one or more selected users (step 216).

In additional embodiments, server computer 150 receives input (e.g., via web dashboard 145) providing feedback which server computer 150 can utilize to modify and update analysis models 152 and the text extractors to increase precision. Precision, in the models and text extractors, is defined as the percentage of social media messages that are extracted that, in fact, should be extracted (as determined by the ground truth) by the text extractors. In evaluating an extractor, the ground truth is how a human would interpret the document (i.e., social media message). To measure precision, a human looks at a sample of input documents returned by the text extractor and verifies that the social media messages should be extracted for the desired task. For example, in order to evaluate an activities extractor, a human (e.g., an individual utilizing client device 140) would read, one by one, a sample of social media messages marked by the extractor as mentioning an activity and count how many indicate that the author is, in fact, talking about an indoor/outdoor activity. The human would mark the social media message, “Cruise for our 40th? There's a 3 day departing the day after my bday???:-):-):-)!” as correct (i.e., indicating that the author is interested in going on a cruise). However, considering the social media message, “I HATE WHEN PEOPLE FLY PAST ME WHILE MY CRUISE IS ON AND GET IN FRONT OF ME AND THEN SLOW DOWN?!”, “MY CRUISE IS ON” refers to the cruise control of the car, so the extracted social media message would be marked as incorrect. The distinctions a human reader makes are quite subtle; in the example above, the likelihood that “MY CRUISE” refers to the car's cruise control as opposed to a vacation cruise is judged according to the context. Sarcasm, figures of speech, puns, and jokes are difficult to deal with, but the text extractors make an attempt by filtering out common figures of speech or dropping any reposts of social media messages, since they can be jokes.

In another embodiment, server computer 150 utilizes another feature, a feedback loop, which accounts for human input. A human (e.g., utilizing web dashboard 145 in client device 140) reads the recommended messages from message analysis program 200 and gives the final decision on whether or not to send a message to a social media user. A history of the choices is maintained (e.g., in storage device 155) and used to build a model that predicts if recommendations should be sent. The prediction problem can be set up as a binary classification problem with the features being the word count of a social media message and the label being the action taken by the human (whether or not a recommendation was sent). Analysis models 152 includes a model that uses a sparse logistic regression to build a probabilistic classifier that takes into account expert knowledge regarding what defines a potentially good social media message. Similarly, an extended system could track social media user responses to recommendation messages and build a model that predicts if the user will respond. Since the feedback loop requires historical data, a new probabilistic classifier is trained whenever a sufficiently large amount of new data is collected.

FIG. 4 depicts a block diagram of components of computer 400, which is representative of client devices 120, 130, and 140, and server computer 150, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media. Software and data 422 are stored in persistent storage 408 for access and/or execution by processors 404 via one or more memories of memory 406. With respect to client devices 120 and 130, software and data 422 includes applications 122 and 132. With respect to client device 140, software and data 422 includes web dashboard 145. With respect to server computer 150, software and data 422 includes analysis models 152, social media data 156, product data 157, and message analysis program 200.

In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 may include one or more network interface cards. Communications unit 410 may provide communications through the use of either or both physical and wireless communications links. Software and data 422 may be downloaded to persistent storage 408 through communications unit 410.

I/O interface(s) 412 allows for input and output of data with other devices that may be connected to computer 400. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data 422 can be stored on such portable computer readable storage media and can be loaded onto persistent storage 408 via I/O interface(s) 412. I/O interface(s) 412 also can connect to a display 420.

Display 420 provides a mechanism to display data to a user and may be, for example, a computer monitor. Display 420 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for analyzing social media messages, the method comprising:
analyzing, by one or more processors, social media messages utilizing a set of topics and keywords associated with a brand;
identifying, by one or more processors, social media messages that include information relating to the brand utilizing the analysis of social media messages utilizing the set of topics and keywords;
determining, by one or more processors, relevancy scores for the identified social media messages that provide an indication of a percentage likelihood that a social media message is related to the brand; and
determining, by one or more processors, one or more recommendations of social media users associated with social media messages based on the determined relevancy scores.

2. The method of claim 1, further comprising:
receiving, by one or more processors, a selection of one or more of the recommendations of social media users; and
sending, by one or more processors, a promotional campaign brand message to the received selection of one or more social media users.

3. The method of claim 1, wherein the analyzing social media messages utilizing a set of topics and keywords associated with a brand, further comprises:
filtering, by one or more processors, social media messages based on context of the social media messages to identify a filtered set of social media messages; and
analyzing, by one or more processors, the filtered set of social media messages utilizing the set of topics and keywords associated with the brand.

4. The method of claim 1, further comprising:
determining, by one or more processors, the set of topics and keywords associated with the brand utilizing a matrix factorization topic model.

5. The method of claim 3, wherein text extractors utilize the set of topics and keywords associated with the brand to identify social media messages, from the filtered set of social medial messages, that include information relating to the brand.

6. The method of claim 1, wherein the determining one or more recommendations of social media users associated with social media messages based on the determined relevancy scores, further comprises:
determining, by one or more processors, which social media messages have a relevancy score that meets or exceeds a threshold condition; and
determining, by one or more processors, one or more recommendations of social media users based on the social media messages that meet or exceed the threshold condition.

7. The method of claim 2, further comprising:
storing, by one or more processors, the received selections of one or more of the recommendations of social media users; and
creating, by one or more processors, an updated analysis model for identifying social media users that include information relating to the brand and an updated analysis model for determining relevancy scores, based on the stored selections of recommendations.

8. A computer program product for analyzing social media messages, the computer program product comprising:
one or more computer readable storage media and program instructions stored on the one or more computer readable storage media, the program instructions comprising:
program instructions to analyze social media messages utilizing a set of topics and keywords associated with a brand;
program instructions to identify social media messages that include information relating to the brand utilizing the analysis of social media messages utilizing the set of topics and keywords;
program instructions to determine relevancy scores for the identified social media messages that provide an indication of a percentage likelihood that a social media message is related to the brand; and
program instructions to determine one or more recommendations of social media users associated with social media messages based on the determined relevancy scores.

9. The computer program product of claim 8, further comprising program instructions, stored on the one or more computer readable storage media, to:
receive a selection of one or more of the recommendations of social media users; and
send a promotional campaign brand message to the received selection of one or more social media users.

10. The computer program product of claim 8, wherein the program instructions to analyze social media messages utilizing a set of topics and keywords associated with a brand, further comprise program instructions to:
filter social media messages based on context of the social media messages to identify a filtered set of social media messages; and
analyze the filtered set of social media messages utilizing the set of topics and keywords associated with the brand.

11. The computer program product of claim 8, further comprising program instructions, stored on the one or more computer readable storage media, to:
determine the set of topics and keywords associated with the brand utilizing a matrix factorization topic model.

12. The computer program product of claim 10, wherein text extractors utilize the set of topics and keywords associated with the brand to identify social media messages, from the filtered set of social medial messages, that include information relating to the brand.

13. The computer program product of claim 8, wherein the program instructions to determine one or more recommendations of social media users associated with social media messages based on the determined relevancy scores, further comprise program instructions to:
determine which social media messages have a relevancy score that meets or exceeds a threshold condition; and
determine one or more recommendations of social media users based on the social media messages that meet or exceed the threshold condition.

14. The computer program product of claim 9, further comprising program instructions, stored on the one or more computer readable storage media, to:
store the received selections of one or more of the recommendations of social media users; and
create an updated analysis model for identifying social media users that include information relating to the brand and an updated analysis model for determining relevancy scores, based on the stored selections of recommendations.

15. A computer system for analyzing social media messages, the computer system comprising:
one or more computer processors;
one or more computer readable storage media; and
program instructions stored on the computer readable storage media for execution by at least one of the one or more processors, the program instructions comprising:
program instructions to analyze social media messages utilizing a set of topics and keywords associated with a brand;
program instructions to identify social media messages that include information relating to the brand utilizing the analysis of social media messages utilizing the set of topics and keywords;
program instructions to determine relevancy scores for the identified social media messages that provide an indication of a percentage likelihood that a social media message is related to the brand; and
program instructions to determine one or more recommendations of social media users associated with social media messages based on the determined relevancy scores.

16. The computer system of claim 15, further comprising program instructions, stored on the computer readable storage media for execution by at least one of the one or more processors, to:
receive a selection of one or more of the recommendations of social media users; and
send a promotional campaign brand message to the received selection of one or more social media users.

17. The computer system of claim 15, wherein the program instructions to analyze social media messages utilizing a set of topics and keywords associated with a brand, further comprise program instructions to:
filter social media messages based on context of the social media messages to identify a filtered set of social media messages; and
analyze the filtered set of social media messages utilizing the set of topics and keywords associated with the brand.

18. The computer system of claim 15, further comprising program instructions, stored on the computer readable storage media for execution by at least one of the one or more processors, to:
determine the set of topics and keywords associated with the brand utilizing a matrix factorization topic model.

19. The computer system of claim 15, wherein the program instructions to determine one or more recommendations of social media users associated with social media messages based on the determined relevancy scores, further comprise program instructions to:
determine which social media messages have a relevancy score that meets or exceeds a threshold condition; and
determine one or more recommendations of social media users based on the social media messages that meet or exceed the threshold condition.

20. The computer system of claim 16, further comprising program instructions, stored on the computer readable storage media for execution by at least one of the one or more processors, to:
store the received selections of one or more of the recommendations of social media users; and
create an updated analysis model for identifying social media users that include information relating to the brand and an updated analysis model for determining relevancy scores, based on the stored selections of recommendations.
